(19) United States
(12) Patent Application Publication
(10) Pub. No.: US 2026/0350627 A1
(43) Pub. Date: Nov. 5, 2026

(54) DECENTRALIZED SECURE CONTENT SHARING USING ARTIFICIAL INTELLIGENCE RETRIEVAL TECHNIQUES

(71) Applicant: INTUIT INC., Mountain View, CA (US)

(72) Inventor: Aram MARTIROSYAN, Agoura Hills, CA (US)

(21) Appl. No.: 19/194,364

(22) Filed: Apr. 30, 2025

(51) Int. Cl. G06Q 20/40; G06F 21/62; G06Q 20/38

(52) U.S. Cl. CPC G06Q 20/407; G06F 21/6218; G06Q 20/382; G06Q 20/401; G06F 2221/2141

(57) ABSTRACT

Embodiments of the present disclosure are directed to a method for sharing relevant content on a blockchain. The method includes determining, using an artificial intelligence retrieval technique, whether encrypted content recorded on the blockchain includes information that is relevant to a query generated based on data that is descriptive of the encrypted content. In response to determining the encrypted content includes information that is relevant to the query, the method includes providing the information and the query as inputs to a generative artificial intelligence model configured to determine whether the information satisfies criteria generated based on the data that is descriptive of the encrypted content. In response to determining the encrypted content does not include information that is relevant to the query, the method includes cancelling a blockchain transaction involving a first user that generated the query and a second user that authored the encrypted content.

Aspects of the present disclosure relate to content sharing and, more particularly, to a decentralized secure content sharing system using artificial intelligence retrieval techniques and embedding vectors with generative artificial intelligence models to identify relevant content for sharing.

### BACKGROUND

Existing content sharing systems pose significant technical challenges. For instance, some existing content sharing systems use third-party publishers to publish content authored by different users. Such third-party publishers generally charge end-users a monetary fee before granting the end-users access to the published content and little, if any, of the monetary fee is shared with the authors of the published content. To help end-users decide whether available content is relevant to their particular purpose (e.g., research), third-party publishers may provide end-users with a free summary (e.g., abstract) of the available content. However, the free summary is generally unhelpful (e.g., too broad) in making such a determination and, in some instances, may result in the end-user purchasing content that is not relevant to their particular purpose. Furthermore, some third-party publishers only allow end-users to purchase the entire content (e.g., an entire document) even though only a portion (e.g., a section) of the content may be relevant to an end-user paying the monetary to access the content.

Other existing content sharing systems, such as Ocean Protocol and Steemit, may allow users to share content directly on a decentralized network, such as a blockchain. Such content sharing systems may also allow users to search the decentralized network for content. However, search capabilities on such content sharing systems is typically limited (e.g., keyword searches only) and may return irrelevant content, thus diminishing the quality of search results.

Accordingly, there is a need for improved searching capabilities on content sharing systems that share content on decentralized networks.

### BRIEF SUMMARY

In some aspects, a method for sharing relevant content on a blockchain typically includes: determining, using an artificial intelligence retrieval technique, whether encrypted content recorded on the blockchain includes information that is relevant to a query generated based on data that is descriptive of the encrypted content; in response to determining the encrypted content includes information that is relevant to the query, providing the information and the query as inputs to a generative artificial intelligence model configured to determine whether the information satisfies criteria generated based on the data that is descriptive of the encrypted content; and in response to determining the encrypted content does not include information that is relevant to the query, cancelling a blockchain transaction involving a first user that generated the query and a second user that authored the encrypted content.

Other embodiments comprise systems configured to perform the method set forth above as well as non-transitory computer-readable storage mediums comprising instructions for performing the method set forth above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a content sharing system, according to certain embodiments of the present disclosure.

FIG. 2 depicts a flow diagram of a method for content sharing, according to certain embodiments of the present disclosure.

FIG. 3A depicts a sequence diagram related to sharing content on a decentralized network, according to certain embodiments of the present disclosure.

FIG. 3B depicts another sequence diagram related to sharing content on a decentralized network, according to certain embodiments of the present disclosure.

FIG. 3C depicts yet another sequence diagram related to sharing content on a decentralized network, according to certain embodiments of the present disclosure.

FIG. 3D depicts still another sequence diagram related to sharing content on a decentralized network, according to certain embodiments of the present disclosure.

FIGS. 4A and 4B depicts an example processing systems for content sharing, according to certain embodiments.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide decentralized, secure knowledge sharing systems.

Content sharing systems according to the present disclosure improve upon searching capabilities of existing content sharing systems (e.g., Ocean Protocol, Steemit, etc.) by providing a multi-tier system for searching private content on a decentralized network, such as a blockchain. The multi-tier system includes a first tier at which artificial intelligence retrieval techniques (e.g., retrieval augmented generation (RAG), graphRAG, or the like) are applied, for example, based on a query generated by a first user based on data (e.g., a summary) descriptive of private content authored by a second user. More specifically, the artificial intelligence retrieval techniques are applied to retrieve relevant information, if any, from the private content based on the query. The multi-tier system also includes a second tier at which a generative artificial intelligence model, such as a large language model (LLM) trained on a large corpus of text, verifies whether the relevant information (e.g., retrieved at the first tier using the artificial intelligence retrieval techniques) satisfies criteria (e.g., matches a particular topic or includes a particular type of information) associated with the query. For instance, in some embodiments, the generative artificial intelligence model may be prompted to generate one output if the relevant information satisfies the criteria and a different output if the relevant information does not satisfy the criteria. By employing this multi-tier system (e.g., artificial intelligence retrieval techniques followed by generative artificial intelligence models), content sharing systems according to the present disclosure provide for improved searching of private content on the blockchain.

Furthermore, content sharing systems according to the present disclosure may control (e.g., cancel or complete) blockchain transactions based on the output of the multi-tier system thereof for searching private content on the blockchain. For instance, if the first tier fails to retrieve any relevant information, the given blockchain transaction may be automatically cancelled. Similarly, if the second tier determines the relevant information output by the first tier does not satisfy the criteria associated with the query, the given blockchain transaction may be automatically cancelled. Otherwise, if the first tier outputs relevant information that is verified at the second tier, the given blockchain transaction may be automatically completed. Still further, content sharing systems according to the present disclosure may allow users involved in successful blockchain transactions to rate one another to establish base reputation scores that may be recorded on the blockchain and, thus, may provide a self-regulating ecosystem in which trust is established through repeated positive interactions and verifiable achievements.

Example aspects of the present disclosure provide numerous technical effects and benefits. For instance, by using a decentralized network (e.g., a blockchain) and encryption (e.g., using public keys and private keys), content sharing systems according to the present disclosure provide for more secure storage of content (e.g., through encryption) and eliminate intermediate parties (e.g., third-party publishers) that are present in existing content sharing systems so that users may instead directly exchange content with one another in a secure manner via the decentralized network. Thus, techniques described herein improve the efficiency, security, and data privacy of content sharing systems. Furthermore, by using a multi-tier system (e.g., artificial intelligence retrieval techniques and generative artificial intelligence models) for searching private content on the blockchain, content sharing systems according to the present disclosure provide improved (e.g., more relevant, more accurate) content compared to existing content sharing systems. Still further, by allowing participants of successful blockchain transactions to rate one another and recording reputations scores for users on the blockchain, content sharing systems according to the present disclosure provide a mechanism to maintain the quality (e.g., accuracy) of content stored on the blockchain. In this manner, computing resource utilization associated with content sharing systems according to the present disclosure may be improved (e.g., more efficient) compared to computing resource utilization associated with existing content sharing systems, because content sharing systems according to the present disclosure are less likely (e.g., due to the artificial intelligence retrieval techniques, and reputation tracking) to complete transactions involving private content on the blockchain that is not relevant to a particular purpose for which a user was searching the blockchain.

### Example Content Sharing System

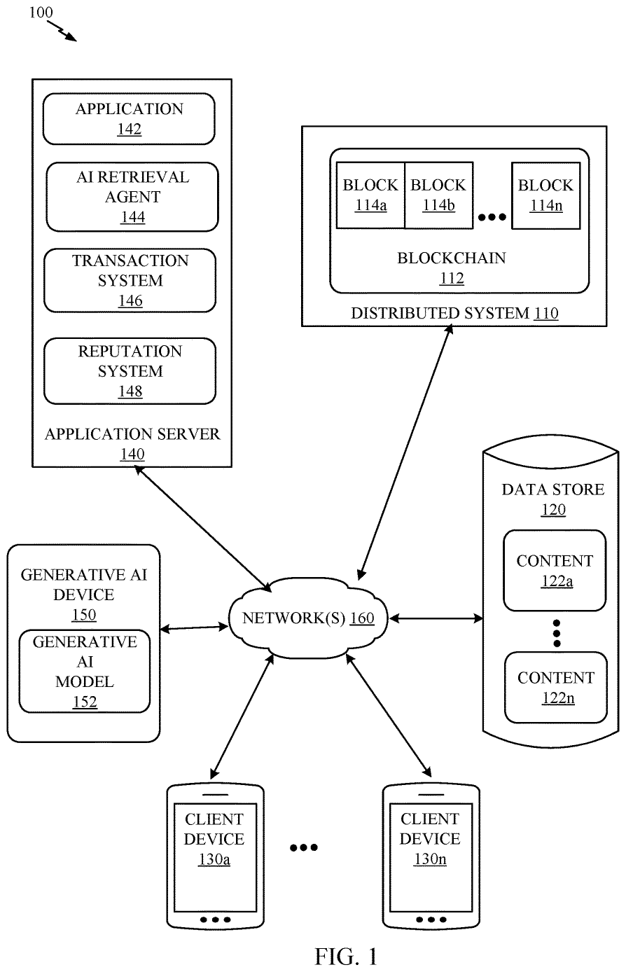

FIG. 1 depicts an example content sharing system 100 according to some embodiments of the present disclosure.

The content sharing system 100 includes a distributed system 110, a data store 120, a plurality of client devices 130a-130n, an application server 140, and a generative artificial intelligence model 150 connected over a network 160. The network 160, in general, may be representative of any type of connection over which data may be transmitted, such as a wide area network (WAN), a local area network (LAN), wireless LAN (WLAN), personal area network (PAN), a cellular network, etc. In a particular embodiment, the network 160 is the Internet.

The distributed system 110 includes one computing device or a plurality of computing devices (e.g., separate computing systems, such as servers) sharing resources and capabilities to provide a blockchain 112 including a plurality of blocks 114a-114n that are linked to one another via cryptography. For instance, each of the blocks 114a-114n may include a cryptographic hash of the previous block in the blockchain 112. Furthermore, each of the blocks 114a-114n may include a timestamp and a unique hash for itself.

The data store 120 may store content 122a-122n. Examples of the different content 122a-122n that may be stored on the data store 120 may include, without limitation, a document, such as a research paper or journal article, and/or a trained machine learning model configured to perform a particular task, such as a generative artificial intelligence model trained to forecast stock prices. It should be appreciated, however, that content 122a-122n may include any suitable type of content generated by an entity (e.g., an individual, a corporation). The content 122a-122n may be stored on the blockchain 112. For instance, a unique hash may be generated (e.g., using a cryptographic hash function) for each respective instance of content 122a-122n that may be stored on the blockchain 112 and uniquely identifies the respective instances of the content 122a-122n. The content 122a-122n stored on the blockchain 112 may either be stored as public content or private content. For private content, data may be generated that is descriptive of the private content.

Client devices 130a-130n may each be representative of a computing system, such as a desktop or laptop computer, tablet, mobile phone, or any other suitable type of computing device. Client devices 130a-130n may interact with the application server 140 (e.g., via the network 160) to access the distributed system 110. For example, client devices 130a-130n may access the distributed system 110 to search the blockchain 112 for content and/or to store content (e.g. as public content or private content) on the blockchain 112.

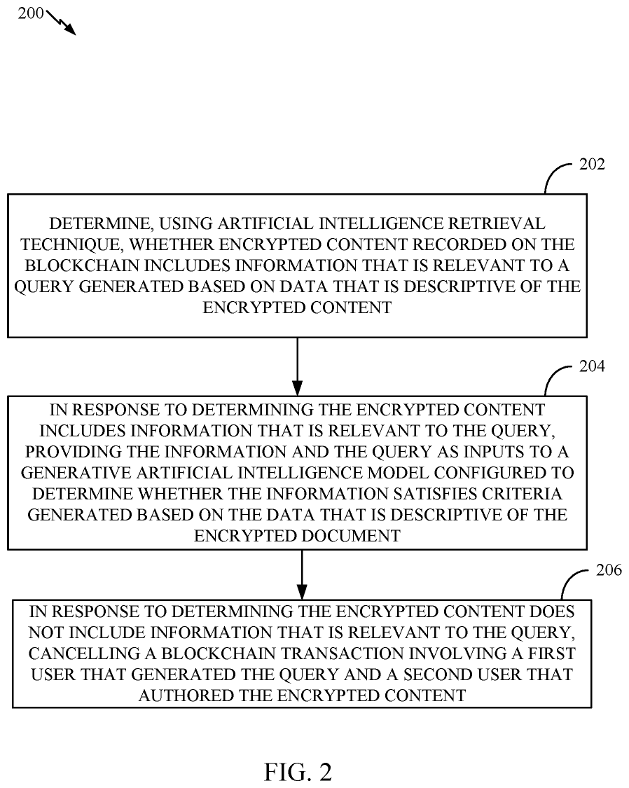

The application server 140 may include a software application 142, an artificial intelligence retrieval agent 144, a transaction system 146, and a reputation system 148. The software application 142 may be used to handle queries received from respective client devices 130a-130n and, as will be discussed below in more detail with reference to FIG. 2A through FIG. 2D, and may be used to facilitate interaction between the other components (e.g., artificial intelligence retrieval agent 144, transaction system 146, reputation system 148) and the generative artificial intelligence device 150.

The artificial intelligence device 150 can include a computing system configured to execute a generative artificial intelligence model 152. The generative artificial intelligence model 152 can include a machine learning model. For instance, in some embodiments, the machine learning model can include a large language model (LLM). It should be understood, however, that the generative artificial intelligence model 152 can include any suitable type of machine learning model.

In some embodiments, the generative artificial intelligence model 152 can be a neural network. Neural networks generally include a collection of connected units or nodes called artificial neurons. The operation of neural networks can be modeled as an iterative process. Each node has a particular value associated with it. In each iteration, each node updates its value based upon the values of the other nodes, the update operation typically consisting of a matrix-vector multiplication. In some cases, a neural network can include one or more aggregation layers, such as a softmax layer.

In some embodiments, training of the generative artificial intelligence model 152 involves a supervised learning process that involves providing training inputs to the machine learning model. The machine learning model can process the training inputs and determines outputs (e.g., relevance of content to input query) based on the training inputs. The outputs are compared to known labels associated with the training inputs (e.g., labels manually applied to training data by experts or otherwise known to be associated with the training inputs, such as based on historical associations) to determine the accuracy of the model, and parameters of the model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for the model, such as based on validation data and test data, as is known in the art.

In some embodiments, the generative artificial intelligence model 152 has been pre-trained, such as based on a large set of training data. The generative artificial intelligence model 152 may also be re-trained on an ongoing basis, such as based on user feedback with respect to outputs produced by the model, thus providing a feedback loop by which generative artificial intelligence model 152 is iteratively improved.

Although FIG. 1 depicts the data store 120 and the artificial intelligence device 150 as being separate from the application server 140, it should be understood that the scope of the present disclosure is intended to cover embodiments in which functionality of at least one of the data store 120 or the generative artificial intelligence device 150 is implemented by the application server 140. Alternatively, or additionally, the generative artificial intelligence model 152 can, in some embodiments, be implemented on the application server 140.

### Example Operations for Decentralized Secure Content Sharing Using Artificial Intelligence Retrieval Techniques and Generative Artificial Intelligence Models to Identify Relevant Content for Sharing

FIG. 2 depicts example operations 200 for a content sharing system according to some embodiments of the present disclosure. For example, operations 200 may be performed using the content sharing system 100 of FIG. 1, and/or one or more other components and/or devices.

Operation 202 includes determining, using an artificial intelligence retrieval technique, whether encrypted content recorded on the blockchain includes information that is relevant to a query generated based on data that is descriptive of the encrypted content. For instance, an artificial intelligence retrieval agent (e.g., the artificial intelligence retrieval agent 144 of FIG. 1) may be configured to execute the artificial intelligence retrieval technique. In some embodiments, the type of artificial intelligence retrieval technique may selected may depend on the encrypted content. For instance, in some embodiments, the encrypted content may be a single document or minimally related documents and, in such embodiments, retrieval augmented generation may be executed on the encrypted content. In other embodiments, the encrypted content may include multiple documents that are interrelated with one another and, in such embodiments, graph retrieval augmented generation may be executed on the encrypted content.

Operation 204 includes in response to determining the encrypted content includes information that is relevant to the query, providing the information and the query as inputs to a generative artificial intelligence model configured to determine whether the information satisfies criteria generated based on the data that is descriptive of the encrypted document. For instance, the generative artificial intelligence model (e.g., generative artificial intelligence model 152) may be configured to

Operation 206 includes in response to determining the encrypted content does not include information that is relevant to the query, cancelling a blockchain transaction involving a first user that generated the query and a second user that authored the encrypted content.

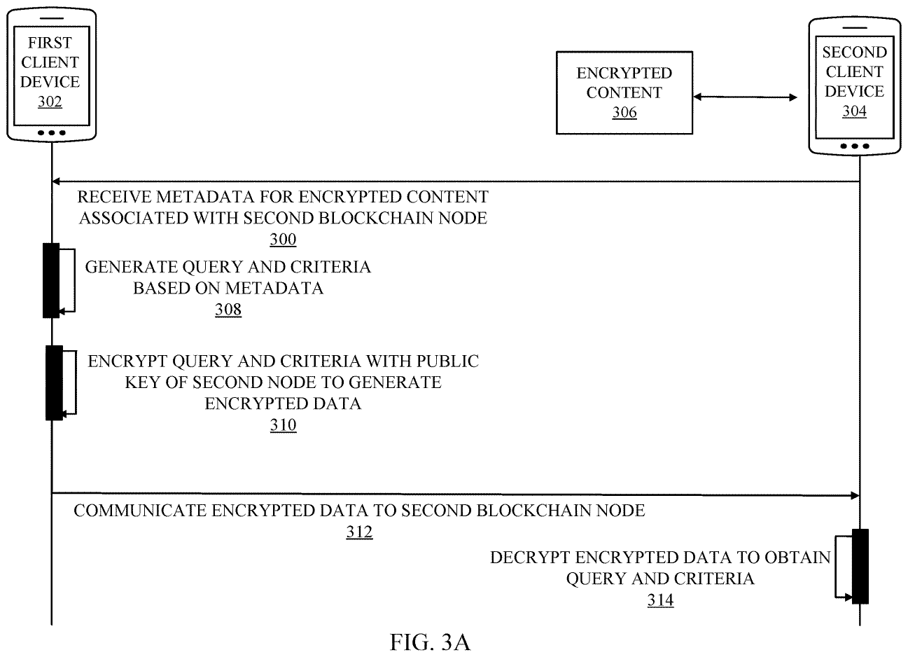

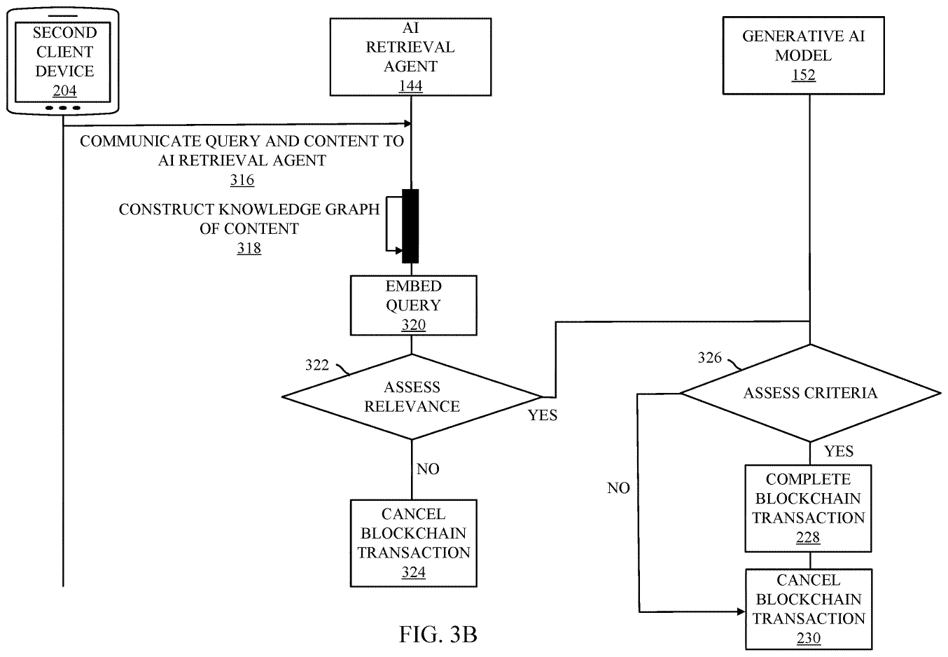

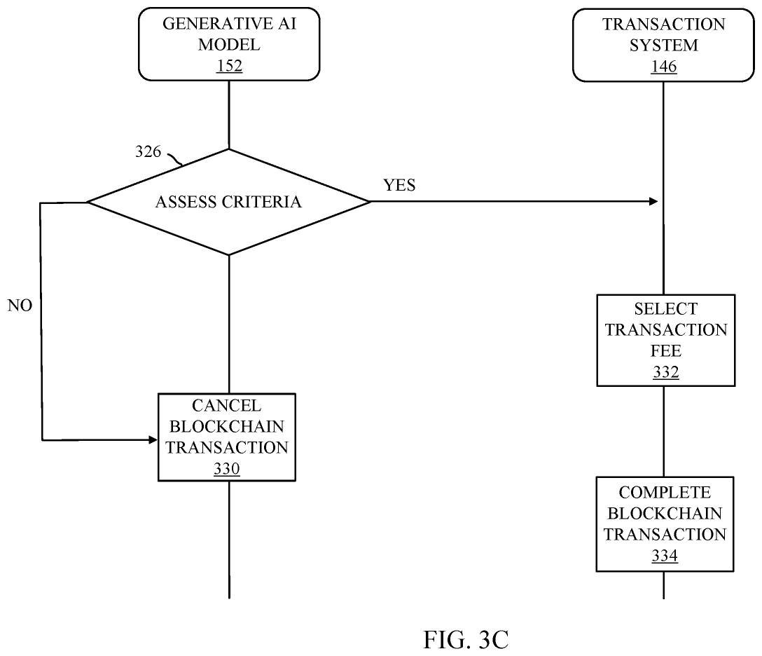

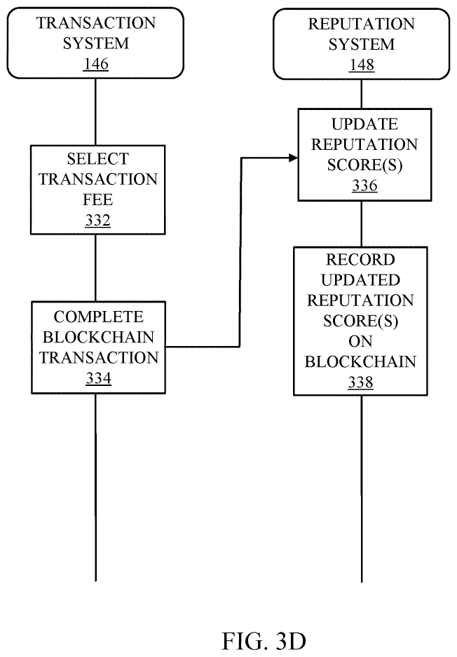

Each of the above operations (e.g., operation 202, 204, 206) will now be discussed in more detail with reference to the sequence diagrams of FIGS. 3A-3D.

### Example Sequence Diagrams Illustrating Secure Sharing of Content on a Blockchain

FIGS. 3A-3D depict sequence diagrams illustrating secure content sharing on a blockchain according to certain embodiments of the present disclosure. For simplicity, the sequence diagrams will be discussed with reference to the content sharing system 100 discussed above with reference to FIG. 1.

At 300, a first user associated with a first client device 302 (e.g., one of the client devices 130a-130n of FIG. 1) may receive data from a second user associated with a second client device 304 (e.g., another one of the client devices 130a-130n of FIG. 1). The data may be descriptive of encrypted content 306 (e.g., private content) authored by the second user and added to the blockchain (e.g., blockchain 112 of FIG. 1).

It should be understood that the encrypted content 306 may include any suitable type of data. For example, in some embodiments, the encrypted content 306 may include one or more documents on a particular subject. In other embodiments, the particular subject may be a mathematical model used by a financial entity to forecast stock prices. In such embodiments, the document(s) may include mathematical proofs for one or more components of the mathematical model.

At 308, the first user associated with the first client device 302 may generate a query and criteria based on the data received at 300. For instance, a user may interact with a user interface on a display of a computing device (e.g., corresponding to the first client device 302) to enter the query and the criteria based on the data. For example, if the encrypted content includes the document(s) on the mathematical model used to forecast stock prices, the query may be whether the document(s) include a mathematical proof for the entire mathematical model or only a portion of the mathematical model. Furthermore, the criteria may be that the first user wants the document(s) in their entirety or, alternatively only the portion(s) of the document(s) that include the mathematical proofs.

At 310, the user-generated query and criteria may be encrypted with a key (e.g., public key) that is unique to the second user (that is, the author of the encrypted content 306) to generate encrypted data.

At 312, the first client device 302 may communicate the encrypted data (that is, the query and criteria encrypted with the public key of the second user) to the second client device 304. At 314, the second client device 304 may decrypt the encrypted data to obtain the query and criteria.

At 316, the second client device 304 may communicate the query, criteria, and unencrypted content (that is, the decrypted version of encrypted content 306) to application server 140, specifically the artificial intelligence retrieval agent 144 hosted on the application server 140.

The artificial intelligence retrieval agent 144 may be configured to implement an artificial intelligence retrieval technique (e.g., RAG or graphRAG) on the unencrypted content. In some embodiments, the artificial intelligence retrieval agent 144 may be configured to select a particular artificial intelligence retrieval technique based on the query. For example, the artificial intelligence retrieval agent 144 may implement RAG for queries requesting information from a single document or minimally related documents. Alternatively, the artificial intelligence retrieval agent 144 may implement graphRAG for queries necessitating a rich contextual understanding of multiple interconnected documents. By using different artificial intelligence retrieval techniques depending on the complexity of the query, the disclosed content sharing system ensures users receive the most relevant and accurate information regardless of query complexity.

As illustrated in FIG. 3B, at 318, the artificial intelligence retrieval agent may implement RAG. More specifically, the artificial intelligence retrieval agent may generate a knowledge graph representing the unencrypted content. The knowledge graph may include a plurality of nodes and a plurality of edges. Each of the plurality of nodes may represent a different concept/topic mentioned in the unencrypted content. Furthermore, each of the plurality of edges in the knowledge graph may represent a relationship among two or more nodes of the knowledge graph.

At 320, the artificial intelligence retrieval agent 144 may be configured to generate an embedding of the query. An embedding generally refers to a vector representation of the query that represents the query as a vector in n-dimensional space.

At 322, the artificial intelligence retrieval agent 144 may be configured to determine the relevance of the unencrypted content to the query. For instance, the artificial intelligence retrieval agent 144 may be configured to convert each of the nodes of the knowledge graph to embeddings (e.g., using Node2Vec) and may compare the embedding of the query to each of the embeddings of the nodes in the knowledge graph to determine if any of the nodes of the knowledge graph are similar to (e.g., close to the embedding of the query in the n-dimensional space) the query. For example, in some embodiments, the artificial intelligence retrieval agent 144 may be configured to implement cosine similarity to measure how similar two vector embeddings are in terms of their orientation.

If the artificial intelligence retrieval agent 144 determines one or more embeddings of nodes of the knowledge graph are similar (e.g., close to the embedding of the query in the n-dimensional space) to the embedding of the query, the generative artificial intelligence model 152 may assess whether the identified relevant content satisfies the criteria specified at 308. Otherwise, the blockchain transaction may be cancelled at 324.

At 326, the generative artificial intelligence model may be prompted to determine whether 322 the relevant content determined at 322 (e. g, using artificial intelligence retrieval techniques) meets the criteria specified at 308. For instance, an example prompt may include a natural language prompt that reads: “You are tasked with determining whether the below information satisfies the following criteria.” Examples of the criteria may include, without limitation, one or more features (e.g., level of access to the private content from which the relevant information is retrieved; a list of topics to which to limit the relevant information based on the query, etc.) For example, a query for the private content may read “Tell me if the private content includes information about airplanes” and the criteria may limit the query to airplanes having a particular type of engine (e.g., jet engine). If the generative artificial intelligence model 152 determines the relevant context meets the criteria, the generative artificial intelligence model 152 may complete the blockchain transaction (or generate an output indicating the blockchain transaction should be completed) at 328. Otherwise, the generative artificial intelligence model 152 cancels the blockchain transaction (or generates an output indicating that the blockchain transaction should be canceled) at 330.

In some embodiments, the generative artificial intelligence model 152 may be fine-tuned with training data that includes example information and criteria and labels indicating whether the information satisfies the criteria. In this manner, the generative artificial intelligence model 152 may be trained (e.g., fine-tuned) using the training data to optimize the generative artificial intelligence model 152 to perform the requested task. It should be appreciated that the training process may involve evaluating an output of the generative artificial intelligence model 152 for a particular instance of training data to the label for the instance of training data. If the output of the generative artificial intelligence model 152 differs from the label, one or more weights of the generative artificial intelligence model 152 may be adjusted and the generative artificial intelligence model 152 may be iteratively trained until the output the generative artificial intelligence model 152 generates for the particular instance of training data matches the label for the particular instance of training data.

It should be understood that completing the blockchain transaction may involve encrypting the relevant content identified by the artificial intelligence retrieval agent 144 using the unique key (e.g., public key) associated with the first user to generate encrypted data, which may then be provided to the first client device 302 via the blockchain 112. The first client device 302 may then use another unique key (e.g., private key) associated with the first user to decrypt the encrypted data. In this manner, the first user may obtain the relevant content. As will now be discussed, in some embodiments, the relevant content that is provided to the first user may vary depending on a selected transaction fee associated with the blockchain transaction.

In some embodiments, a multi-tier transaction fee structure may be used for each blockchain transaction that occurs on the blockchain. For example, the multi-tier transaction fee structure may include a first tier (e.g., lowest tier) that specifies a minimal fee to charge to determine if the encrypted content 306 associated with the second client device 304 includes relevant content per the query and criteria specified by the first user associated with the first client device 302.

The multi-tier transaction fee structure may include a second tier (e.g., next to lowest tier) that specifies an increased fee to charge the first user to obtain specific chunks of the relevant content identified (e.g., by the embedding vectors) by the artificial intelligence retrieval agent 144 at 332 as discussed above.

The multi-tier transaction fee structure may include a third tier (e.g., next to highest tier) that specifies an even higher fee (e.g., relative to the fee specified in the second tier) to charge the first user to access entire sections containing the relevant content identified by the artificial intelligence retrieval agent 144.

The multi-tier transaction fee structure may include a fourth tier (e.g., highest tier) that specifies a highest fee to charge the first user to access the encrypted content in its entirety.

As shown in FIG. 2C, at 332, the transaction system 146 may, in response to the generative artificial intelligence model 152 determine the relevant content identified by the artificial intelligence retrieval agent 144 satisfies the criteria specified at 308, select one of the plurality of different tiers (e.g., first tier, second tier, third tier, fourth tier) of the multi-tier transaction fee structure as the selected tier for the given blockchain transaction. In some embodiments, the criteria generated at 308 may indicate which of the plurality of different tiers is selected for the given blockchain transaction. After selecting the appropriate transaction fee, the transaction system 146 may complete the blockchain transaction at 334.

In some embodiments, the content sharing system (e.g., content sharing system 100 of FIG. 1) may allow participants of successful blockchain transactions to rate one another. For example, the encrypted data provided to the first user to complete the blockchain transaction may include a token that the first user may use to rate the blockchain transaction involving the second user. In this manner, the token allows the first user to provide a verified review of the second user.

In some embodiments, the reputation stores for different users of the blockchain 112 may be stored separately from the encrypted content. For example, the reputation scores may be stored in an Ethereum smart contract, and the encrypted content may be stored in an InterPlanteary File System (IPFS).

### Example Computing Systems

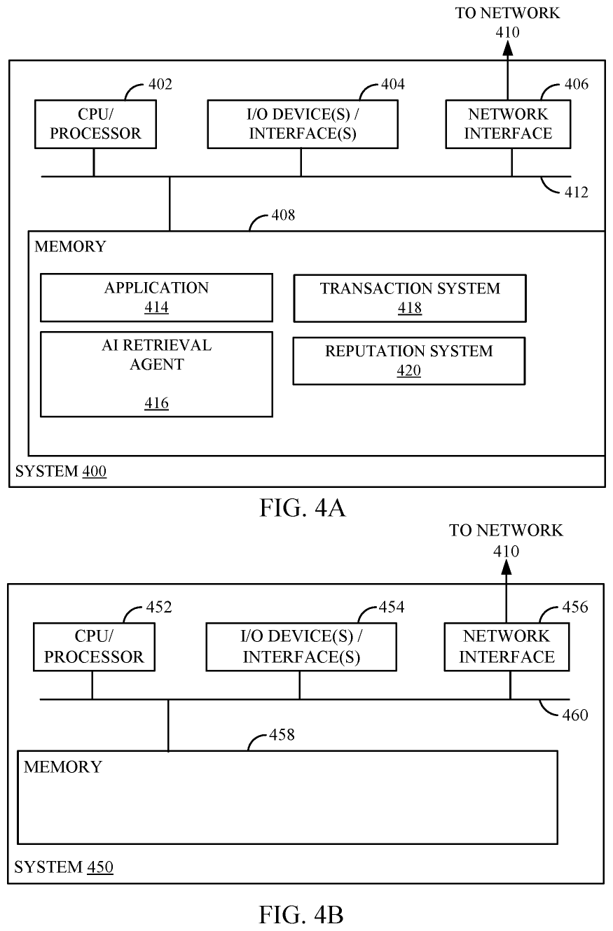

FIG. 4A illustrates an example computing system 400 with which the content sharing system 100 of FIG. 1 may be implemented. For example, the computing system 400 may be representative of the application server 140 of FIG. 1.

The computing system 400 includes a central processing unit (CPU) 402, one or more I/O device interfaces 404 that may allow for the connection of various I/O devices 404 (e.g., keyboards, displays, mouse devices, pen input, etc.) to the computing system 400, a network interface 406, a memory 408, and an interconnect 412. It is contemplated that one or more components of the computing system 400 may be located remotely and accessed via a network 410. It is further contemplated that one or more components of the computing system 400 may include physical components or virtualized components.

The CPU 402 may retrieve and execute programming instructions stored in the memory 408. Similarly, the CPU 402 may retrieve and store application data residing in the memory 408. The interconnect 412 transmits programming instructions and application data, among the CPU 402, the I/O device interface 404, the network interface 406, the memory 408. The CPU 402 is included to be representative of a single CPU, multiple CPUs, a single CPU having multiple processing cores, and other arrangements.

Additionally, the memory 408 is included to be representative of a random access memory or the like. In some embodiments, the memory 408 may include a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, the memory 408 includes an application 414, an artificial intelligence retrieval agent 416, a transaction system 418, and a reputation system, which may be representative of the software application 142, the artificial intelligence retrieval agent 144, the transaction system 146, and the reputation system 148 of FIG. 1.

FIG. 4B illustrates an example computing system 450 with which embodiments of the disclosure related to the content sharing system 100 of FIG. 1 may be implemented. For example, the computing system 450 may be representative of the client devices 130a-130n of FIG. 1.

The computing system 450 includes a central processing unit (CPU) 452, one or more I/O device interfaces 454 that may allow for the connection of various I/O devices 454 (e.g., keyboards, displays, mouse devices, pen input, etc.) to the computing system 450, a network interface 456, a memory 458, and an interconnect 460. It is contemplated that one or more components of the computing system 450 may be located remotely and accessed via the network 410. It is further contemplated that one or more components of the computing system 450 may include physical components or virtualized components.

The CPU 452 may retrieve and execute programming instructions stored in the memory 458. Similarly, the CPU 452 may retrieve and store application data residing in the memory 458. The interconnect 440 transmits programming instructions and application data, among the CPU 452, the I/O device interface 454, the network interface 456, the memory 458. The CPU 452 is included to be representative of a single CPU, multiple CPUs, a single CPU having multiple processing cores, and other arrangements.

Additionally, the memory 458 is included to be representative of a random access memory or the like. In some embodiments, the memory 458 may include a disk drive, solid state drive, or a collection of storage devices distributed across multiple storage systems. Although shown as a single unit, the memory 458 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for sharing relevant content on a blockchain, comprising:
determining, using an artificial intelligence retrieval technique at a first tier of a multi-tier system, whether encrypted content recorded on the blockchain includes information that is relevant to a query generated based on data that is descriptive of the encrypted content, wherein the determining comprises:
selecting one of a plurality of different artificial intelligence retrieval techniques as a selected artificial intelligence retrieval technique based on the encrypted content, wherein the plurality of different artificial intelligence retrieval techniques comprise a retrieval augmented generation (RAG) technique and a graph RAG technique; and
determining, using the selected artificial intelligence retrieval technique, whether the encrypted content includes information that is relevant to the query; and
in response to determining the encrypted content includes information that is relevant to the query, providing the information and the query as inputs to a generative artificial intelligence model that is included in a second tier of the multi-tier system and is configured to determine whether the information satisfies criteria generated based on the data that is descriptive of the encrypted content; or
in response to determining the encrypted content does not include information that is relevant to the query, cancelling a blockchain transaction involving a first user that generated the query and a second user that authored the encrypted content.

2. The method of claim 1, further comprising:
obtaining an output of the generative artificial intelligence model, the output indicating whether the information satisfies the criteria; and
in response to the output indicating the information does not satisfy the criteria, cancelling the blockchain transaction.

3. The method of claim 1, further comprising:
obtaining an output of the generative artificial intelligence model, the output indicating whether the information satisfies the criteria; and
in response to the output indicating the information satisfies the criteria, completing the blockchain transaction.

4. The method of claim 3, wherein completing the blockchain transaction comprises:
receiving a verified review of the second user by the first user; and
updating a reputation score for the second user based on the verified review; and
recording the updated reputation score for the second user on the blockchain.

5. The method of claim 3, wherein completing the blockchain transaction comprises:
selecting one of a plurality of different transaction fees as a selected transaction fee for the blockchain transaction; and
applying the selected transaction fee to the first user via the blockchain.

6. The method of claim 5, wherein each of the different transactions fees is associated with granting the first user a different level of access to the encrypted content.

7. The method of claim 6, wherein the plurality of different transaction fees comprise:
a first transaction fee granting the first user no access to the encrypted content;
a second transaction fee that is higher than the first transaction fee, the second transaction fee granting the first user access to the information;
a third transaction fee that is higher than the second transaction fee, the third transaction fee granting the first user access to sections of the encrypted content that include the information; and
a fourth transaction fee that is higher than the third transaction fee, the fourth transaction fee granting the first user access to the encrypted content.

8. (canceled)

9. The method of claim 1, wherein:
the encrypted content comprises a single document; and
the selected artificial intelligence retrieval technique comprises the RAG technique.

10. The method of claim 1, wherein:
the encrypted content comprises multiple interconnected documents; and
the selected artificial intelligence retrieval technique comprises the graph RAG technique.

11. A content sharing system for sharing relevant content on a blockchain, comprising:
one or more processors; and
one or more memory configured to store computer executable instructions that, when executed by the one or more processors, cause the one or more processors to perform operations comprising:
determining, using an artificial intelligence retrieval technique at a first tier of a multi-tier system, whether encrypted content recorded on the blockchain includes information that is relevant to a query generated based on data that is descriptive of the encrypted content, wherein the determining comprises:
selecting one of a plurality of different artificial intelligence retrieval techniques as a selected artificial intelligence retrieval technique based on the encrypted content, wherein the plurality of different artificial intelligence retrieval techniques comprise a retrieval augmented generation (RAG) technique and a graph RAG technique; and
determining, using the selected artificial intelligence retrieval technique, whether the encrypted content includes information that is relevant to the query; and
in response to determining the encrypted content includes information that is relevant to the query, providing the information and the query as inputs to a generative artificial intelligence model that is included in a second tier of the multi-tier system and is configured to determine whether the information satisfies criteria generated based on the data that is descriptive of the encrypted content; or
in response to determining the encrypted content does not include information that is relevant to the query, cancelling a blockchain transaction involving a first user that generated the query and a second user that authored the encrypted content.

12. The content sharing system of claim 11, further comprising:
obtaining an output of the generative artificial intelligence model, the output indicating whether the information satisfies the criteria; and
in response to the output indicating the information does not satisfy the criteria, cancelling the blockchain transaction.

13. The content sharing system of claim 11, further comprising:
obtaining an output of the generative artificial intelligence model, the output indicating whether the information satisfies the criteria; and
in response to the output indicating the information satisfies the criteria, completing the blockchain transaction.

14. The content sharing system of claim 13, further comprising:
in response to the output indicating the information does not satisfy the criteria, cancelling the blockchain transaction.

15. The content sharing system of claim 13, wherein completing the blockchain transaction comprises:
receiving a verified review of the second user by the first user; and
updating a reputation score for the second user based on the verified review; and
recording the updated reputation score for the second user on the blockchain.

16. The content sharing system of claim 13, wherein completing the blockchain transaction comprises:
selecting one of a plurality of different transaction fees as a selected transaction fee for the blockchain transaction; and
applying the selected transaction fee to the first user via the blockchain.

17. The content sharing system of claim 16, wherein each of the different transactions fees is associated with granting the first user a different level of access to the encrypted content.

18. The content sharing system of claim 16, wherein the plurality of different transaction fees comprise:
a first transaction fee granting the first user no access to the encrypted content;
a second transaction fee that is higher than the first transaction fee, the second transaction fee granting the first user access to the information;
a third transaction fee that is higher than the second transaction fee, the third transaction fee granting the first user access to sections of the encrypted content that include the information; and
a fourth transaction fee that is higher than the third transaction fee, the fourth transaction fee granting the first user access to the encrypted content.

19. (canceled)

20. The content sharing system of claim 11, wherein:
the encrypted content comprises a single document; and
the selected artificial intelligence retrieval technique the graph RAG technique.
